(19) United States
(12) Patent Application Publication
(10) Pub. No.: US 2025/0337344 A1
(43) Pub. Date: Oct. 30, 2025

(54) PIEZOELECTRIC MOTOR HAVING INCHWORM AND ULTRASONIC MODES

(71) Applicant: Seagate Technology LLC, Fremont, CA (US)

(72) Inventors: Xiong Liu, Shugart (SG); Brendon Shi Wei Leong, Shugart (SG); Barish Chakravarty, Shugart (SG)

(21) Appl. No.: 19/186,026

(22) Filed: Apr. 22, 2025

Related U.S. Application Data
(60) Provisional application No. 63/637,932, filed on Apr. 24, 2024.

(51) Int. Cl. H02N 2/02

(52) U.S. Cl. CPC H02N 2/023

(57) ABSTRACT

Described are three-transducer piezoelectric motors capable of being operated in an ultrasonic mode over a narrow range of driving frequencies and of being operated in an inchworm mode at driving frequencies outside of, and below, the narrow range. The piezoelectric motors are designed such that all three transducers have the same or nearly the same expansion resonant frequency, thus enabling the motors to be operated in an ultrasonic mode when using a driving frequency at or near the expansion resonant frequency, as well as being operable in a normal inchworm mode at other driving frequencies. The inchworm mode allows for precise and controlled positioning and movement, whereas the ultrasonic mode allows for large movements over short periods.

### RELATED APPLICATION

The present application claims the benefit under 35 U.S.C. § 119(e) of U.S. Provisional Patent Application 63/637,932 filed on Apr. 24, 2024, which is hereby incorporated by reference in its entirety.

The disclosure relates to piezoelectric motors, and specifically to piezoelectric motors having a three-transducer design.

### SUMMARY

In accordance with certain aspects, the present disclosure describes a three-transducer piezoelectric motor capable of being operated in an ultrasonic mode over a narrow range of driving frequencies and of being operated in an inchworm mode at driving frequencies outside of and lower than the narrow range.

In accordance with certain aspects, the present disclosure describes a three-transducer piezoelectric motor for generating linear motion of a slider. Such a three-transducer piezoelectric motor includes a first piezoelectric transducer and a second piezoelectric transducer disposed between a third piezoelectric transducer, the first and second piezoelectric transducers arranged to frictionally engage with the slider in an alternating fashion such that expansion and contraction of the third piezoelectric transducer functions to move the slider. Each of the first, second, and third piezoelectric transducers have substantially the same expansion resonance frequencies such that when the first, second, and third piezoelectric transducers are all driven at a frequency at or near their expansion resonance frequencies, the motor operates in an ultrasonic mode, and otherwise the motor operates in an inchworm mode.

In certain aspects, the ultrasonic mode of the three-transducer piezoelectric motor has a characteristic speed that is at least about 1000 times faster than that of the inchworm mode. For example, the inchworm mode may have a characteristic speed expressed in tenths of mm/sec or less, and the ultrasonic mode may have a characteristic speed expressed in tenths of m/sec or more.

In certain aspects, the first, second, and third piezoelectric transducers are made of a hard ceramic piezoelectric material such as lead zirconium titanate, for example PZT-4.

In certain aspects, the first, second, and third piezoelectric transducers have expansion resonance frequencies that are within about 3% of each other.

In certain aspects, the first and second piezoelectric transducers have length, width, and depth dimensions of about 28 mm by 3.8 mm by 2.0 mm, and the third piezoelectric transducer has length, width, and depth dimensions of about 20 mm by 5.0 mm by 2.0 mm. In certain aspects, the expansion resonance frequencies of the first, second, and third piezoelectric transducers are all about 58.5 kHz.

In certain aspects, the first and second piezoelectric transducers have length, width, and depth dimensions of about 12.6 mm by 3.8 mm by 0.7 mm, and the third piezoelectric transducer has length, width, and depth dimensions of about 10 mm by 3.8 mm by 2.1 mm. In certain aspects, the expansion resonance frequencies of the first, second, and third piezoelectric transducers are all about 134.9 kHz.

In certain aspects, the first and second piezoelectric transducers each include a tip configured to frictionally engage with the slider. The tips may have a pyramidal or semispherical shape, for example a truncated pyramid, truncated semisphere, or other similar shape.

In certain aspects, the three-transducer piezoelectric motor further includes a preload mechanism configured to adjust an amount of preload between the first and second piezoelectric transducers and the slider. In certain aspects, the third piezoelectric transducer is mounted to a mounting block of the preload mechanism.

In certain aspects, the three-transducer piezoelectric motor is configured as a rail-type motor or as a clamp-type motor.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIGS. 1A-1E schematically show the operation of a rail-type three-transducer piezoelectric motor.

FIGS. 2A-2E schematically show the operation of a clamp-type three-transducer piezoelectric motor.

FIG. 3 schematically depicts the dimensions and relations involved in designing three-transducer piezoelectric motors in accordance with aspects of the present disclosure.

FIG. 4 schematically represents signals applied to the transducers during operation of a three-transducer piezoelectric motor.

FIG. 5A schematically depicts a preloading subassembly for use in mounting and preloading a three-transducer piezoelectric motor in accordance with aspects of the present disclosure.

FIG. 5B schematically depicts a three-transducer assembly mounted on a preloading subassembly.

### DETAILED DESCRIPTION

The present disclosure relates to piezoelectric motors designed to function in an inchworm motor mode and in an ultrasonic motor mode. In particular, the present disclosure describes three-transducer piezoelectric motors that are designed so that all three transducers have the same or nearly the same expansion resonant frequency, thus enabling the motors to be operated in an ultrasonic mode when using a driving frequency at or near the expansion resonant frequency, as well as being operable in a normal inchworm mode at other driving frequencies. The inchworm mode allows for precise and controlled positioning and movement, whereas the ultrasonic mode allows for large movements over short periods.

An inchworm motor is a device that uses piezoelectric actuators to move a slider (also referred to as a shaft or a rail) with nanometer precision. Such a motor is commonly used in precision instruments and processes, for example scanning tunneling microscopes and patch clamping of biological cells. While inchworm motor functionality is typically geared toward nanometer scale control, the tradeoff for such precise control is very low speed, for example tenths of millimeters per second or less. In accordance with the present disclosure, an ultrasonic mode can be accessed in three-actuator piezoelectric inchworm motors by properly designing the transducers to have matching, or nearly matching, expansion resonant frequencies. By matching or nearly matching, it is meant that the expansion resonant frequencies of the individual transducers to be within about 3% of each other. When the expansion resonance frequencies of the three actuators are so designed, it is possible to operate the resulting piezoelectric motor in two distinct modes depending on the driving frequency. One mode, called the inchworm mode, achieves the precise position control characteristic of the normal operation of an inchworm motor, and utilizes a lower driving frequency outside of a narrow range centered around the expansion resonance frequencies of the three actuators. The other mode, called the ultrasonic mode, achieves high-speed motion from one location to another due to the simultaneous excitation of the expansion modes of all three actuators when utilizing a driving frequency within a narrow range centered around the expansion resonance frequencies of the three actuators. In the ultrasonic mode, the actuators that move the slider may vibrate in elliptical paths, thus producing a frictional contact between their tips and the slider to move the slider at high speed, for example tenths of meters per second or more.

As will be recognized, three-transducer piezoelectric motors can be structured using three separate piezoelectric devices or using a single piezoelectric device having three pairs of electrodes. Without loss of generality, the present disclosure will simply refer to a three-transducer piezoelectric motor, which encompasses both constructions, and will describe the transducers as if they were separate devices. Moreover, it will be appreciated that the terms “transducer,” “actuator,” “piezo,” “piezoelectric device,” and “PZT” may be used interchangeably throughout the present disclosure (even though PZT is an acronym often used to specifically refer to ceramic piezoelectric materials in the lead zirconium titanate family).

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding and are not meant to be scale drawings that accurately represent size or shape of elements.

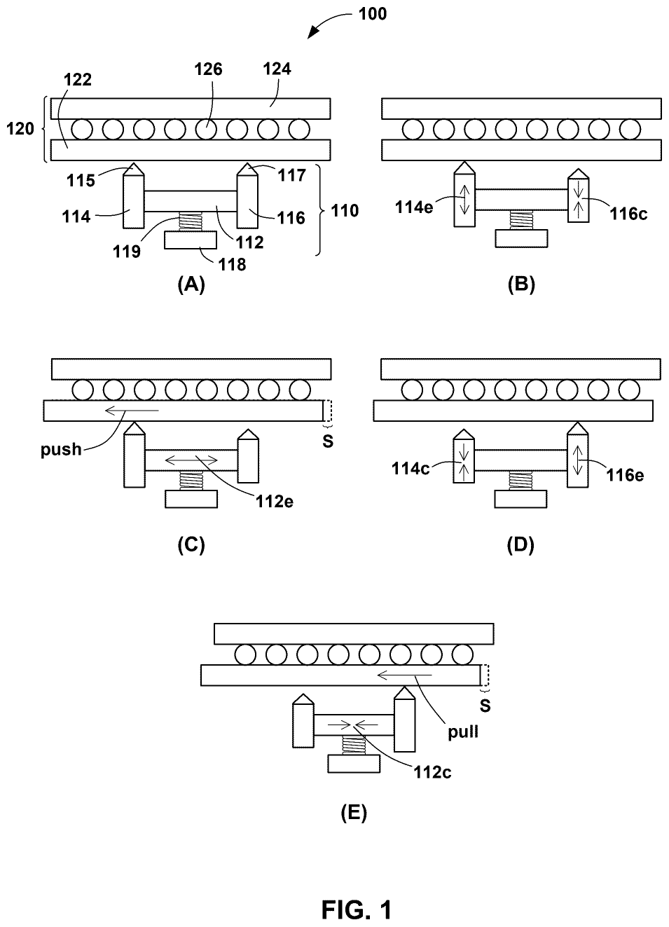

FIGS. 1A-1E schematically depict an example three-transducer piezoelectric motor 100 as well as steps in the operation of the motor. Motor 100 may be called a rail-type motor because it utilizes a moving rail assembly 120 that includes a movable rail 122 that moves relative to a stationary rail 124 with the aid of a bearing mechanism such as ball bearings 126. The actuator assembly 110 includes two longitudinally-oriented piezoelectric transducers 114 and 116 that are joined by one laterally-oriented piezoelectric transducer 112. As used herein, the longitudinal and lateral orientations are relative to the direction of motion imparted by the motor, with longitudinal being roughly perpendicular to the direction of motion and lateral being roughly parallel to the direction of motion.

In FIG. 1, the piezoelectric transducers (PZT) 112, 114, and 116 form the three transducers of the three-transducer piezoelectric motor 100. The PZTs 112, 114, and 116 may be any suitable piezoelectric materials, and preferably a hard ceramic piezoelectric material such as the lead zirconium titanate material known as PZT-4. A tip 115 is provided on PZT 114 for engagement with rail 122, and likewise tip 117 is provided on PZT 116. Tips 115 and 117 may be any desired shape (for example, a truncated pyramid or semispherical shape) and material (for example, ceramic) appropriate for the application, and are often selected for their hardness, durability, and frictional properties. Actuator assembly 110 may be supported by a base 118 and a rod 119, with the height of rod 119 being adjustable to provide a desired amount of preload of the actuator assembly 110 against the rail assembly 120.

FIG. 1A shows an initialization phase in which actuator assembly 110 is preloaded against the rail assembly 120 to produce the desired relationship between tips 115 and 117 and the movable rail 122. In FIG. 1B, longitudinal transducer 114 is expanded 114e while longitudinal transducer 166 is contracted 116c so that frictional contact is made between tip 115 and movable rail 122, and so that there is no contact between tip 117 and movable rail 122. As shown in FIG. 1C, while longitudinal transducers 114 and 116 are in their respective expanded and contracted states, lateral transducer 112 is expanded 112e, thus resulting in a displacement of movable rail 122 by an amount S as the tip 115 essentially “pushes” the moveable rail 122 in the direction of the push arrow. As shown in FIG. 1D, while lateral transducer 112 remains in its expanded state, longitudinal transducer 114 is contracted 114c and longitudinal transducer 116 is expanded 116e so that contact is made between tip 117 and movable rail 122, and so that the contact between tip 115 and movable rail 122 is removed. As shown in FIG. 1E, while longitudinal transducers 114 and 116 are in their respective contracted and expanded states, lateral transducer 112 is contracted 112c, thus resulting in a displacement of movable rail 122 by an amount S as the tip 117 essentially “pulls” the moveable rail 122 in the direction of the pull arrow. Moveable rail 122 can be moved in the opposite direction by reversing the steps shown in FIG. 1.

As depicted, FIGS. 1B-1E demonstrate the principle of inchworm motion utilizing three-transducer piezoelectric motor 100. The amount of displacement S at each push and pull is known as the stroke length, which can be controlled by the voltage applied to lateral transducer 112. In accordance with the present disclosure, when PZTs 112, 114, and 116 have matching or near matching expansion resonance frequencies and the PZTs are driven at or near such frequencies, an ultrasonic mode is induced in which the magnitude of the motor stroke is greatly amplified.

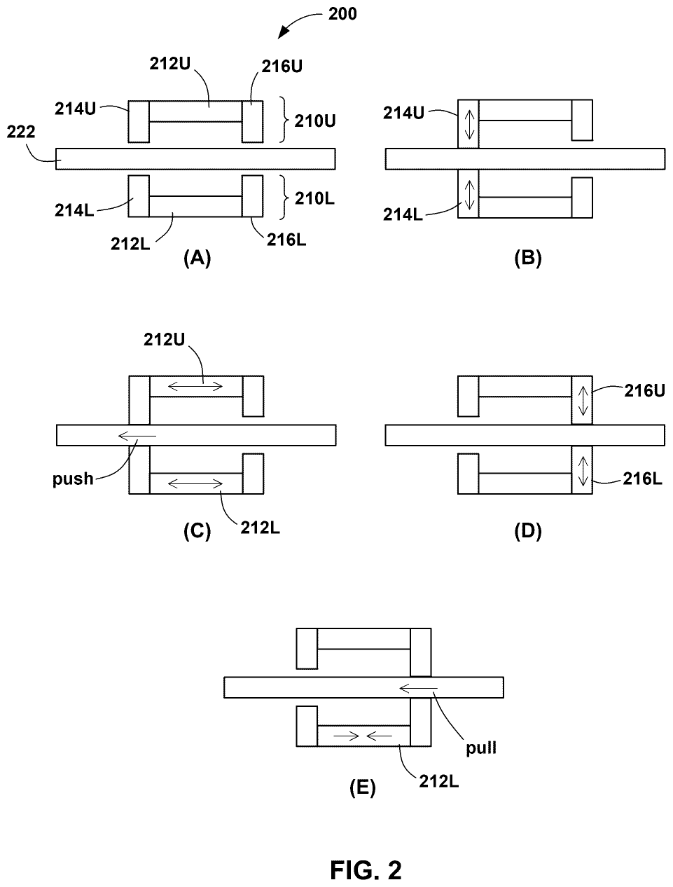

FIGS. 2A-2E schematically depict another example three-transducer piezoelectric motor 200 as well as steps in the operation of the motor. Motor 200 may be called a clamp-type motor because moves a slider 222 in conjunction with a clamping mechanism imparted by actuator assemblies positioned on opposing sides of the slider 222. Upper actuator assembly 210U includes two longitudinally-oriented piezoelectric transducers 214U and 216U that are joined by one laterally-oriented piezoelectric transducer 212U. Likewise, the opposing lower actuator assembly 210L includes two longitudinally-oriented piezoelectric transducers 214L and 216L that are joined by one laterally-oriented piezoelectric transducer 212L. Actuator assemblies 210U and 210L work in concert to engage and move slider 222. Because each actuator assembly 210U and 210L include three transducers, the overall design of motor 200 is considered a three-transducer piezoelectric motor.

The operation of motor 200 is similar to the push and pull operation shown in FIG. 1. In an initialization phase seen in FIG. 2A, the actuator assemblies 210U and 210L are positioned relative to the slider 222. In FIG. 2B, opposing longitudinal transducers 214U and 214L are expanded to “grip” or “clamp” the slider 222 therebetween. As shown in FIG. 2C, while longitudinal transducers 214U and 214L are clamping slider 222, the lateral transducers 212U and 212L are expanded, thus resulting in a linear displacement of slider 222 as it is pushed by the grip of longitudinal transducers 214U and 214L in the direction of the push arrow. As shown in FIG. 2D, while lateral transducers 212U and 212L remain expanded, the opposing longitudinal transducers 214U and 214L are retracted while opposing longitudinal transducers 216U and 216L are expanded to grip slider 222. As shown in FIG. 2E, while longitudinal transducers 216U and 216L are clamping slider 222, the lateral transducers 212U and 212L are contracted, thus resulting in a linear displacement of slider 222 as it is pulled by the grip of longitudinal transducers 216U and 216L in the direction of the pull arrow. Motion in the other direction can be effectuated by reversing the steps shown in FIG. 2.

Similar to FIG. 1, the steps of FIG. 2 demonstrate the principle of inchworm motion, but instead utilizing a clamp-type three-transducer piezoelectric motor 200. In accordance with the present disclosure, when PZTs 212U, 212L, 214U, 214L, 216U, and 216L have matching or near matching expansion resonance frequencies, PZTs can be operated in an ultrasonic mode that greatly amplifies the speed and displacement of the motion imparted to the slider 222. While FIGS. 1 and 2 schematically depict examples of three-transducer piezoelectric motors, it will be appreciated that the design of PZTs having matching or near matching expansion resonance frequencies to enable both an inchworm mode of operation and an ultrasonic mode of operation can be applied to any three-transducer piezoelectric motor construction.

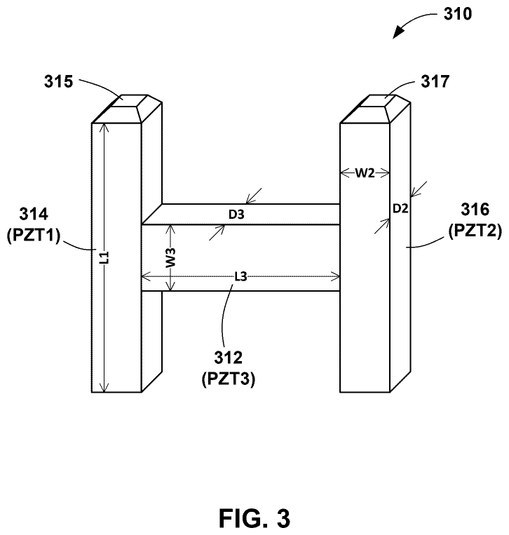

FIG. 3 schematically depicts an actuator assembly 310 that includes two longitudinal PZTs 314 and 316, also identified as PZT1 and PZT2 respectively, that are joined together by a lateral PZT 312, also identified as PZT3. A tip 315 is disposed on an end of PZT1 for contacting a movable slider (not shown), and similarly a tip 317 is disposed on the same end of PZT2. PZT1 and PZT2 have the same shape, orientation, and dimensions such that the length L1 of PZT1 is the same as the length of PZT2, and the width W2 and depth D2 of PZT2 is the same as the width and depth of PZT1. The lateral PZT3 has a length L3, width W3, and depth D3 as indicated. Preferably the depth D3 of PZT3 is the same as the depth D2 of PZT2 and therefore the same as the depth of PZT1.

For a motor using the actuator assembly 310, the speed of the inchworm mode is determined by various properties of PZT3, namely the length L3, the width W3, the number of PZT layers, and the piezoelectric coefficient, as well as the voltage and frequency of the driving signal. For example, assuming length L3=10 mm, depth D3=1 mm, the number of PZT layers is n=10, the piezoelectric coefficient is d=−110×10⁻¹² m/V, the driving voltage is v =40 V, and the frequency is f=10 kHz, then the motor speed will be 0.44 mm/sec, which is given by the equation: speed=(L3/D3)×d×v×f×n.

For a motor using the actuator assembly 310 in which the expansion resonance frequency of PZT1 and PZT2 is matched to that of PZT3, the speed of the motor operating in ultrasonic mode is determined by the magnitude of the expanding mode of PZT3 at resonance frequency as well as the driving voltage and the frequency of the expanding mode. The magnitude of the expanding mode, which is typically expressed in microns per volt, combines the mechanical quality factor of the PZT, Qm (which is a value published for each PZT, and reflects the degree of mechanical loss caused by the internal friction of the PZT during resonance), the size of the PZT, the number of PZT layers, and the PZT piezoelectric coefficient. For the same PZT3 having length L3=10 mm, depth D3 =1 mm, the number of PZT layers n=10, the piezoelectric coefficient d=−110×10⁻¹² m/V, and a Qm=600, the magnitude of the expanding mode is 0.212 microns/V. As such, for an expanding mode frequency of 134.9 kHz and a 10 V driving voltage, the motor speed in ultrasonic mode will be 0.642 m/sec, which is over 1000 times faster than the speed in inchworm mode.

The expanding resonance frequency of a PZT is largely dependent on the material and dimensions of the transducer. Preferably, hard ceramic PZTs are used, for example the lead zirconium titanate PZT materials commonly referred to as PZT-4 and PZT-8. Two examples of expanding resonance frequency matched designs utilizing piezoelectric transducers made from PZT-4 are as follows. In reference to FIG. 3, the first design includes a PZT1 and PZT2 having dimensions of length=28 mm, width=3.8 mm, and depth=2.0 mm; and a PZT3 having dimensions of length=20 mm, width=5.0 mm, and depth=2.0 mm. The resulting matched expanding resonance frequency is about 58.5 kHz. The second design includes a PZT1 and PZT2 having dimensions of length=12.6 mm, width=3.8 mm, and depth=0.7 mm; and a PZT3 having dimensions of length=10 mm, width=3.8 mm, and depth=2.1 mm. The resulting matched expanding resonance frequency is about 134.9 kHz.

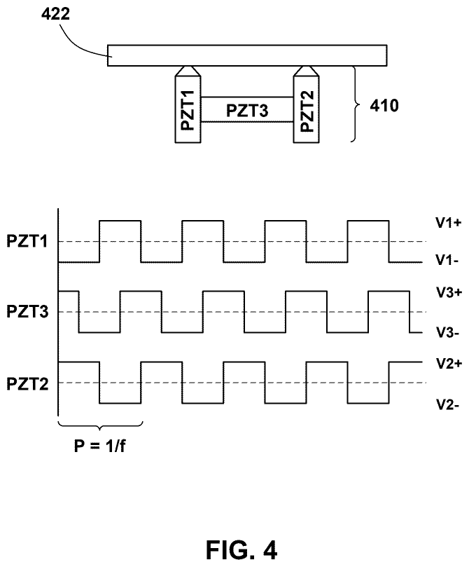

FIG. 4 schematically depicts the signals that drive each of the PZT transducers in a three-transducer piezoelectric motor in accordance with the present disclosure. In reference to actuator assembly 410, which is composed of two longitudinal transducers PZT1 and PZT2 to engage with a slider 422, and a lateral transducer PZT3 disposed between them to advance the slider 422, the square wave forms indicate the signals being applied to each transducer. Typically, the signals applied to PZT1 and PZT2 are the same amplitude (V+ and V−) and frequency (f), while being exactly 180 degrees out of phase. In this way, PZT1 is always expanded when PZT2 is contracted, and PZT1 is always contracted when PZT2 is expanded. As such, over the duration of one period P, each of PZT1 and PZT2 will spend half the time in expansion and half the time in contraction. The waveform applied to PZT3 is also the same frequency (f), while being 90 degrees out of phase with each of the PZT1 and PZT2 signals. As shown, PZT3 expands when PZT1 is engaged with slider 422, and PZT3 contracts when PZT2 is engaged with slider 422. Such a signal would move slider 422 to the left on the page. Moving the slider 422 to the right on the page would involve inverting the PZT3 signal. While the frequencies are the same, the voltage (or signal amplitude) driving PZT3 need not be the same voltage used to drive PZT1 and PZT2.

The signal waveforms shown in FIG. 4 are applicable to both inchworm mode and ultrasonic mode. The most significant difference between the two modes is the driving frequency used. In ultrasonic mode, the driving frequency is close to the expansion resonance frequency of the transducers and is preferably within a narrow range centered around the expansion resonance frequency of the transducers, where narrow range means within about 3%. In inchworm mode, the driving frequency used is outside of this narrow range and is preferably much lower than the expansion resonance frequency of the transducers, for example one-half to one-third as much.

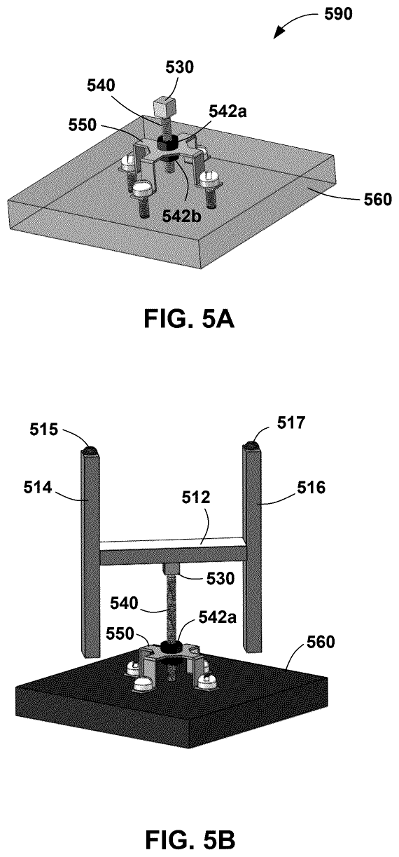

FIG. 5A schematically illustrates a preload mechanism subassembly 590 for use with three-transducer assemblies in accordance with the present disclosure. Proper preloading helps ensure full engagement between the transducers and the rail assembly to thereby ensure proper performance, particularly in ultrasonic mode. Preload mechanism subassembly 590 includes a mounting block 530, spring plate 550, preload rod 540, preload adjustment nuts 542a and 542b, and base plate 560. The amount of preload applied can be adjusted by nuts 542a and 542b to either increase or reduce the length of the upper section of the preload rod 540. FIG. 5B shows the same preload mechanism with the lateral transducer 512 of a three-transducer assembly mounted to mounting block 540. The transducer assembly includes a longitudinal transducer 514 on one end of lateral transducer 512 and another longitudinal transducer 516 on the other end of lateral transducer 512. Tips 515 and 517 are disposed on respective longitudinal transducers 514 and 516 to provide frictional engagement with a movable rail (not shown).

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” and so forth, means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A three-transducer piezoelectric motor for generating linear motion of a slider, the motor comprising:
a first piezoelectric transducer and a second piezoelectric transducer disposed between a third piezoelectric transducer, the first and second piezoelectric transducers arranged to frictionally engage with the slider in an alternating fashion such that expansion and contraction of the third piezoelectric transducer functions to move the slider,
wherein the first, second, and third piezoelectric transducers have substantially the same expansion resonance frequencies such that when the first, second, and third piezoelectric transducers are all driven at a frequency at or near their expansion resonance frequencies, the motor operates in an ultrasonic mode, and otherwise the motor operates in an inchworm mode.

2. The three-transducer piezoelectric motor of claim 1, wherein the ultrasonic mode has a characteristic speed that is at least about 1000 times faster than that of the inchworm mode.

3. The three-transducer piezoelectric motor of claim 2, wherein the inchworm mode has a characteristic speed expressed in tenths of mm/sec or less, and the ultrasonic mode has a characteristic speed expressed in tenths of m/sec or more.

4. The three-transducer piezoelectric motor of claim 1, wherein the first, second, and third piezoelectric transducers have expansion resonance frequencies that are within about 3% of each other.

5. The three-transducer piezoelectric motor of claim 1, wherein the first, second, and third piezoelectric transducers are comprised of a PZT-4 material.

6. The three-transducer piezoelectric motor of claim 5, wherein the first and second piezoelectric transducers have length, width, and depth dimensions of about 28 mm by 3.8 mm by 2.0 mm, and the third piezoelectric transducer has length, width, and depth dimensions of about 20 mm by 5.0 mm by 2.0 mm.

7. The three-transducer piezoelectric motor of claim 6, wherein the expansion resonance frequencies of the first, second, and third piezoelectric transducers are all about 58.5 kHz.

8. The three-transducer piezoelectric motor of claim 5, wherein the first and second piezoelectric transducers have length, width, and depth dimensions of about 12.6 mm by 3.8 mm by 0.7 mm, and the third piezoelectric transducer has length, width, and depth dimensions of about 10 mm by 3.8 mm by 2.1 mm.

9. The three-transducer piezoelectric motor of claim 8, wherein the expansion resonance frequencies of the first, second, and third piezoelectric transducers are all about 134.9 kHz.

10. The three-transducer piezoelectric motor of claim 1, wherein the first and second piezoelectric transducers each include a tip configured to frictionally engage with the slider.

11. The three-transducer piezoelectric motor of claim 10, wherein the tips have a truncated pyramid shape or a truncated semisphere shape.

12. The three-transducer piezoelectric motor of claim 1, further comprising a preload mechanism configured to adjust an amount of preload between the first and second piezoelectric transducers and the slider.

13. The three-transducer piezoelectric motor of claim 12, wherein the third piezoelectric transducer is mounted to a mounting block of the preload mechanism.

14. The three-transducer piezoelectric motor of claim 1 configured as a rail-type motor.

15. The three-transducer piezoelectric motor of claim 1 configured as a clamp-type motor.

16. A three-transducer piezoelectric motor capable of being operated in an ultrasonic mode over a narrow range of driving frequencies and of being operated in an inchworm mode at driving frequencies outside of and lower than the narrow range.

17. The three-transducer piezoelectric motor of claim 16 comprising piezoelectric transducers made of a PZT-4 material.

18. The three-transducer piezoelectric motor of claim 16, wherein the ultrasonic mode has a speed that is at least about 1000 times greater than that of the inchworm mode.
